(19) United States
(12) Patent Application Publication
(10) Pub. No.: US 2004/0029639 A1
(43) Pub. Date: Feb. 12, 2004

(54) Automated output, archival, and retrieval method and system for managing information and documents associated with winnings received from a casino game

(76) Inventor: John Regan, San Clemente, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/215,097

(22) Filed: Aug. 8, 2002

(51) Int. Cl. A63F 13/00

(52) U.S. Cl. 463/42

(57) ABSTRACT

This invention is directed to a method and system for generating, archiving, and retrieving information associated with winnings received by a patron from casino games. A system user inputs transaction information about a patron's winning and transmits the information to a document output module, which parses the transaction information to create index data and then generates bar codes from the index data. It then determines whether the winnings are over a specified tax reporting limit and if the winnings are over such limit, generating a tax form containing selected transaction information, tax information, and the bar codes associated therewith. Transaction related forms containing selected transaction information and the bar codes associated therewith are also generated.

The forms are provided to the system user and the patron, wherein the system user and the patron enter additional required information onto the forms to complete the forms. The completed forms are scanned into a document archival and retrieval module. OCR and bar code recognition are performed on the scanned forms to determine if the OCR and bar code readings match and if a required number of images per transaction were scanned. The scanned forms are archived within the document archival and retrieval module.

### BACKGROUND OF THE INVENTION

This invention is directed to a method and system for generating, archiving, and retrieving information associated with winnings received by a patron from casino games. More particularly, this invention is directed to a method and system for generating, archiving, and retrieving jackpot/fill slips and associated tax documents in connection with winnings received from a gaming machine.

A casino must generate, track, and manage information and associated documents relating to winnings received by patrons from casino games and gaming machines. In addition, if the winnings received are more than a specified amount, the casino must generate certain tax documents in order for the patron to report his winnings to the Internal Revenue Service. Prior methods used preprinted forms or dot matrix printers to generate the required forms. The forms were then completed manually. The taxes owed and the amounts to be paid to the patron also had to be calculated manually. The completed forms were archived in their original paper state and off site storage was required to store the paper forms. These methods used manual labor for ordering, generating, sorting, storing, and retrieving these required documents and were prone to errors.

There is a need for an automated method and system for generating, archiving, and retrieving information associated with winnings received by a patron from casino games which reduces labor costs and minimizes human errors.

### SUMMARY OF THE INVENTION

In accordance with the present invention, there is provided an automated method and system for generating, archiving, and retrieving information associated with winnings received by a patron from casino games.

Further, in accordance with the present invention, there is provided an automated method and system for generating, archiving, and retrieving information associated with winnings received by a patron from casino games which reduces labor costs, minimizes human errors, automates manual processes, decreases retrieval time, and assists with regulatory compliance.

Still further, in accordance with the present invention, there is provided an automated method and system for generating, archiving, and retrieving selected documents associated with winnings received by a patron from a casino game using a distributed computing system. The method and system comprise receiving system user input comprising transaction information representative of data associated with a patron receiving notice of winnings from a selected casino game and transmitting the transaction information to a document output module. The document output module parses the transaction information create index data representative of the transaction information and then generates data representative of bar codes from the index data. It then determines at the document output module whether the winnings are over a specified tax reporting limit and if the winnings are over a specified tax reporting limit, generating at least one tax form containing selected transaction information, tax information, and the bar codes associated therewith. A least one transaction related form containing selected transaction information and the bar codes associated therewith is also generated at the document output module.

At least one form is provided to at least one system user and the patron, wherein the at least one system user and the patron enter additional required information onto the at least one form to complete the at least one form. The at least one completed form is selectively scanned into a document archival and retrieval module. Optical character and bar code recognition are performed on the scanned forms at the document archival and retrieval module to determine if the optical character and bar code readings match and if a required number of images per transaction were scanned. If the readings do not match or if there are not the required number of images per transaction, the rejected readings and the corresponding image are transmitted to a rejection queue, wherein in the rejection queue, the rejected readings and corresponding images are reviewed and corrections are made to the at least one form associated therewith. The scanned forms are selectively archived in a specified location within the document archival and retrieval module.

An advantage of the present invention is that it provides an automated method and system for generating, archiving, and retrieving information associated with winnings received by a patron from casino games which reduces labor costs and minimizes human errors.

Another advantage of the present invention is that it provides an automated method and system for generating, archiving, and retrieving information associated with winnings received by a patron from casino games which automates manual processes, decreases retrieval time, and assists with regulatory compliance.

In order that the present invention may be more clearly understood, preferred forms will be described with reference to the following drawings.

These and other advantages, aspects, and features will be understood by one of ordinary skill in the art upon the reading and understanding of the specification.

### BRIEF DESCRIPTION OF THE DRAWINGS

FIGS. 1a, 1b, and 1c show flowchart illustrating a preferred method for generating, archiving, and retrieving information associated with winnings received by a patron from casino games according to the present invention.

FIG. 2 shows a diagram of a layout of casino using the method and system according to the present invention.

FIG. 3 shows a diagram of a layout of another embodiment using the method and system according to the present invention.

FIG. 4 illustrates a sample screen for the document archival and retrieval database showing folders for archiving the scanned documents.

FIG. 5 shows a sample W-2G document generated by the method and system of the present invention.

FIG. 6 shows a sample accounting and cashier form generated by the method and system of the present invention.

### DETAILED DESCRIPTION OF THE INVENTION

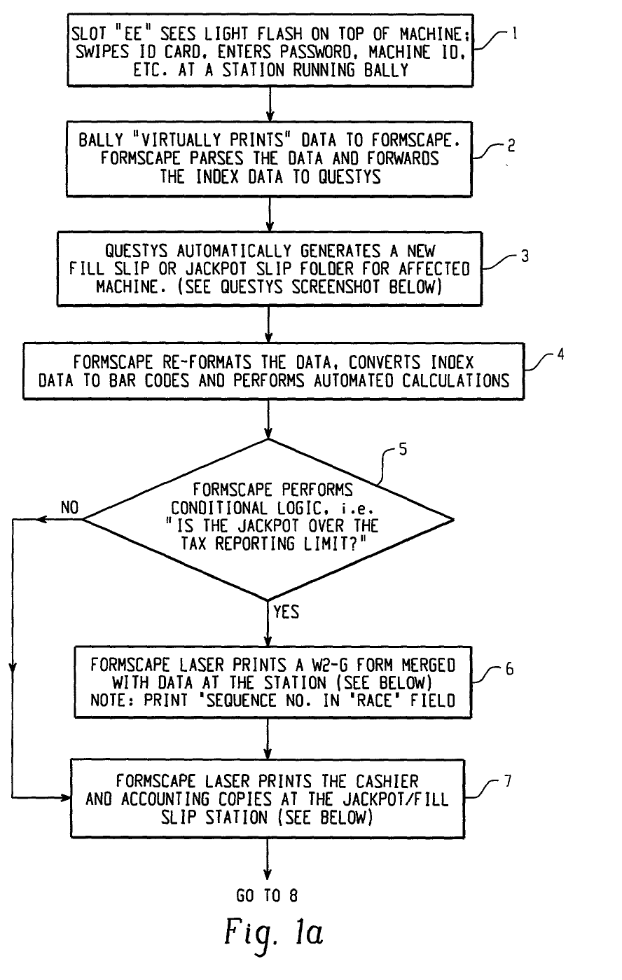

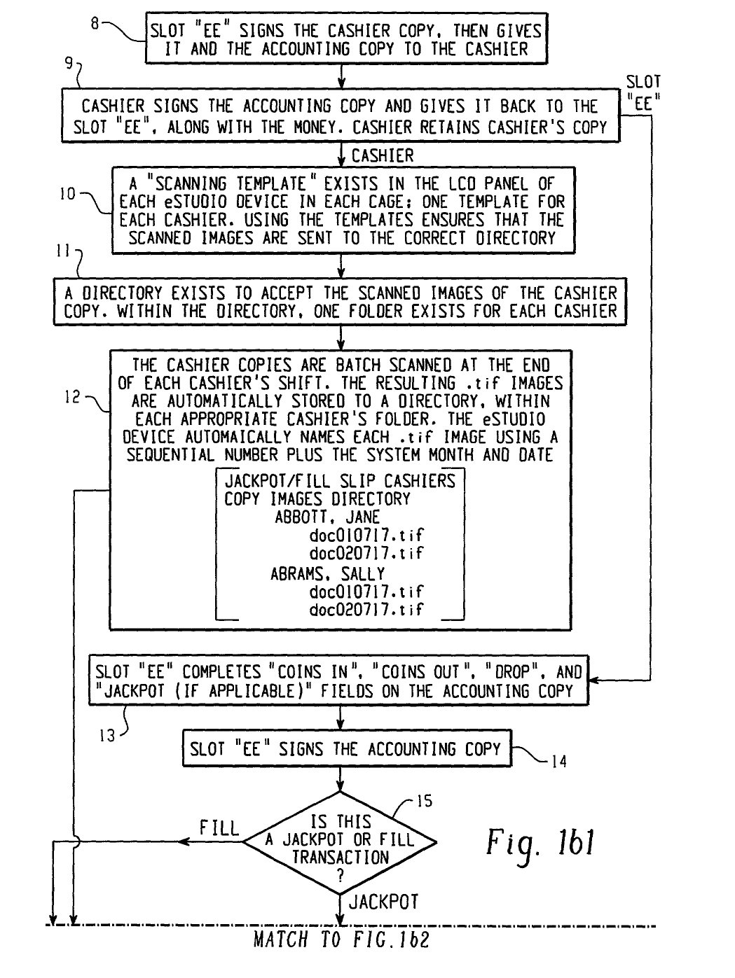

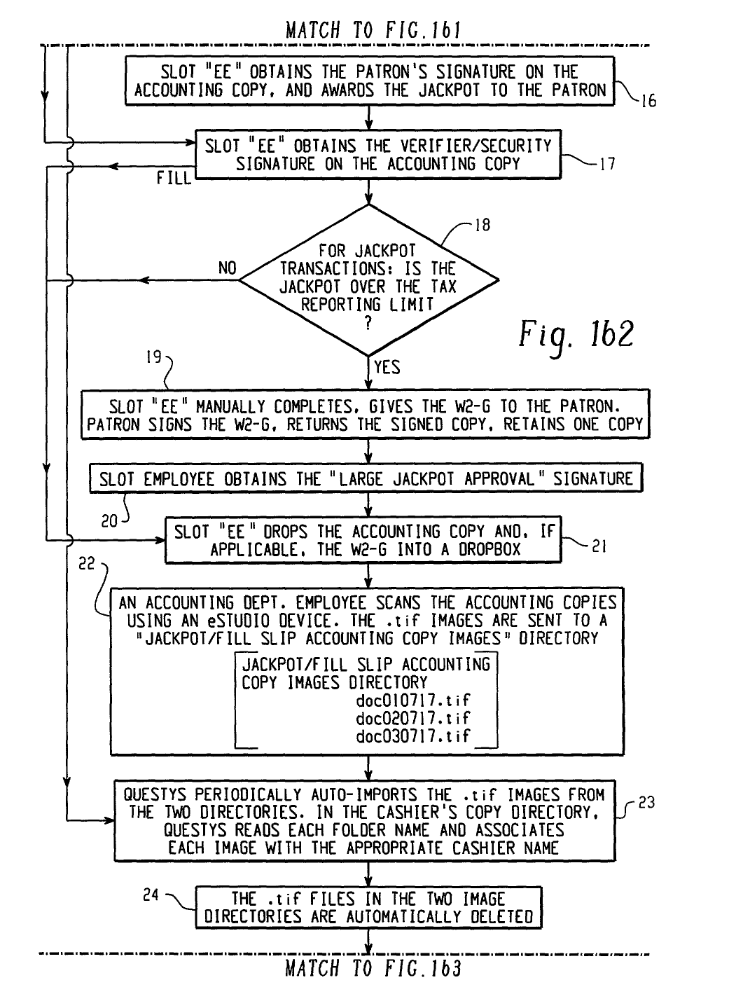

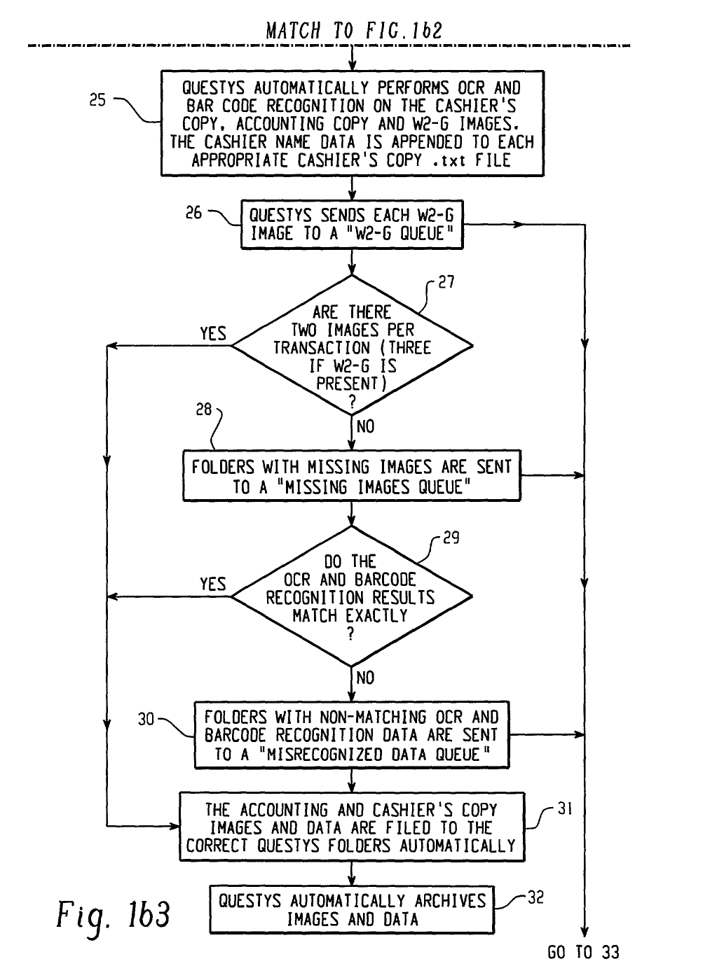

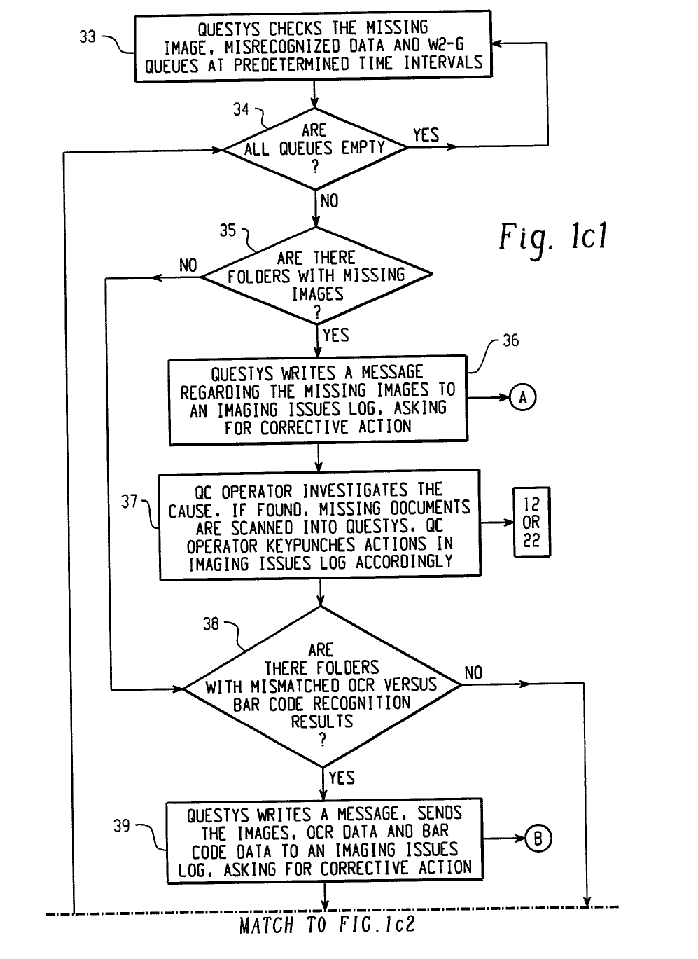

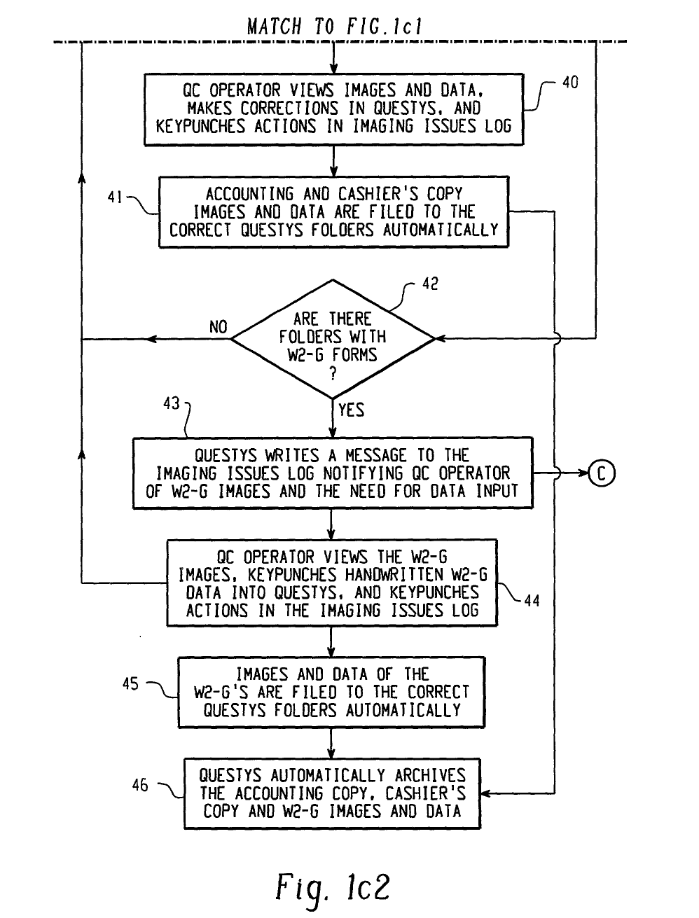

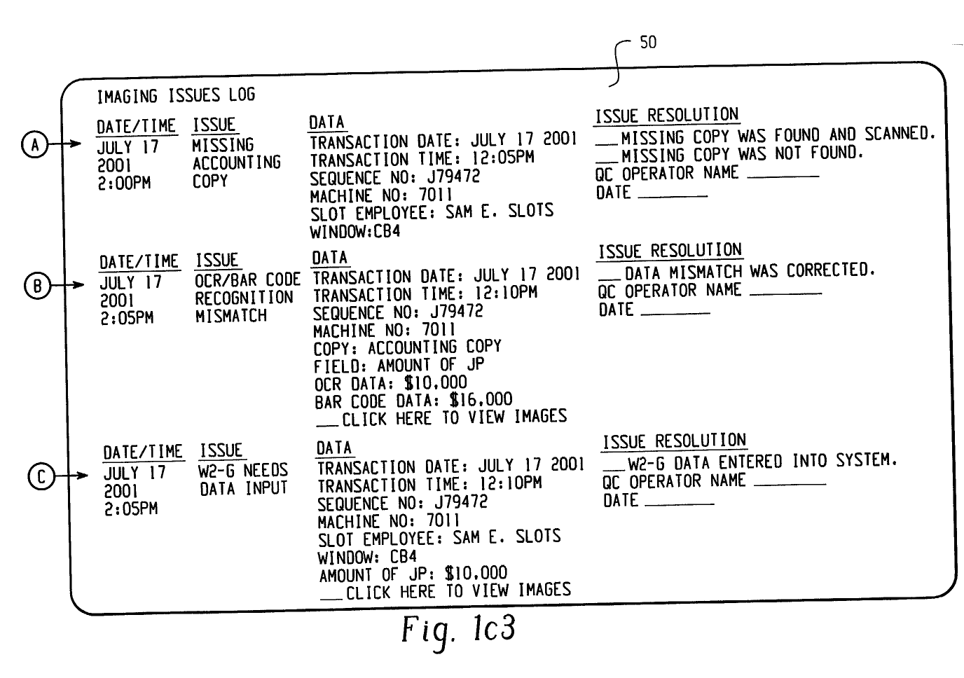

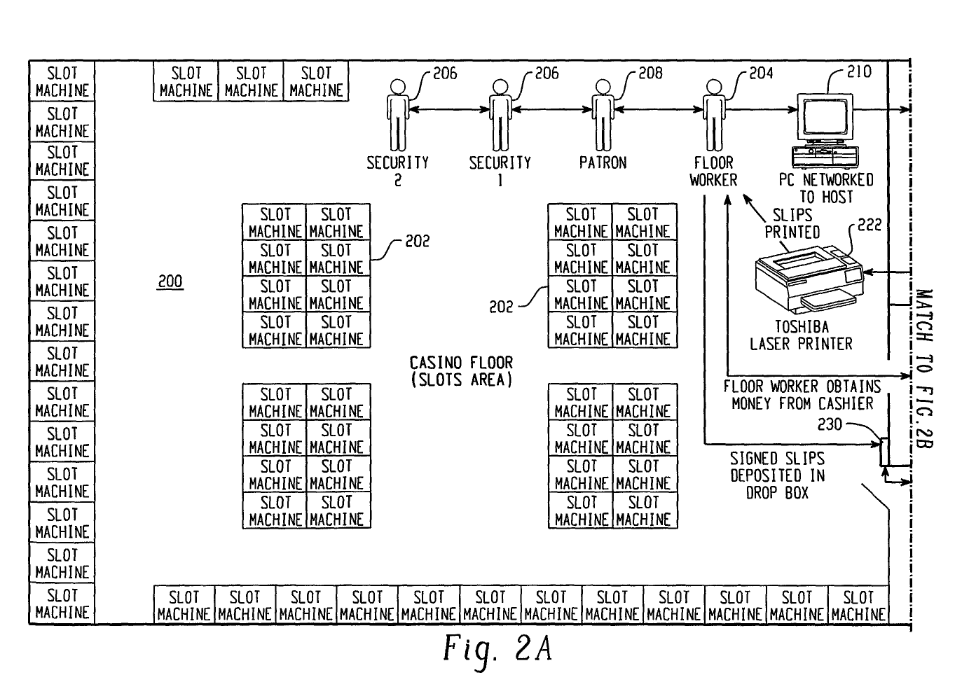

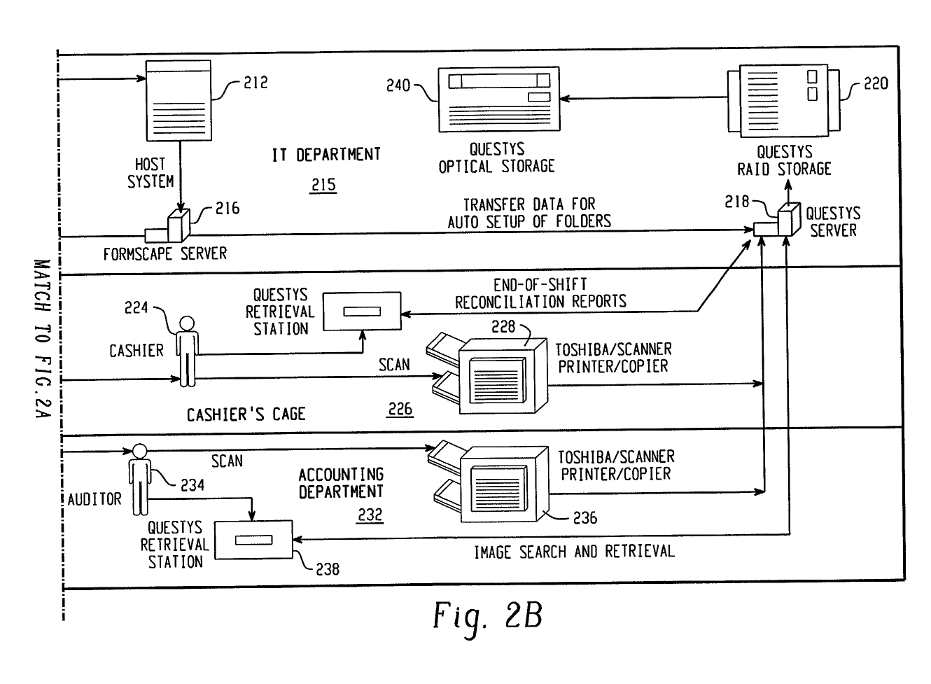

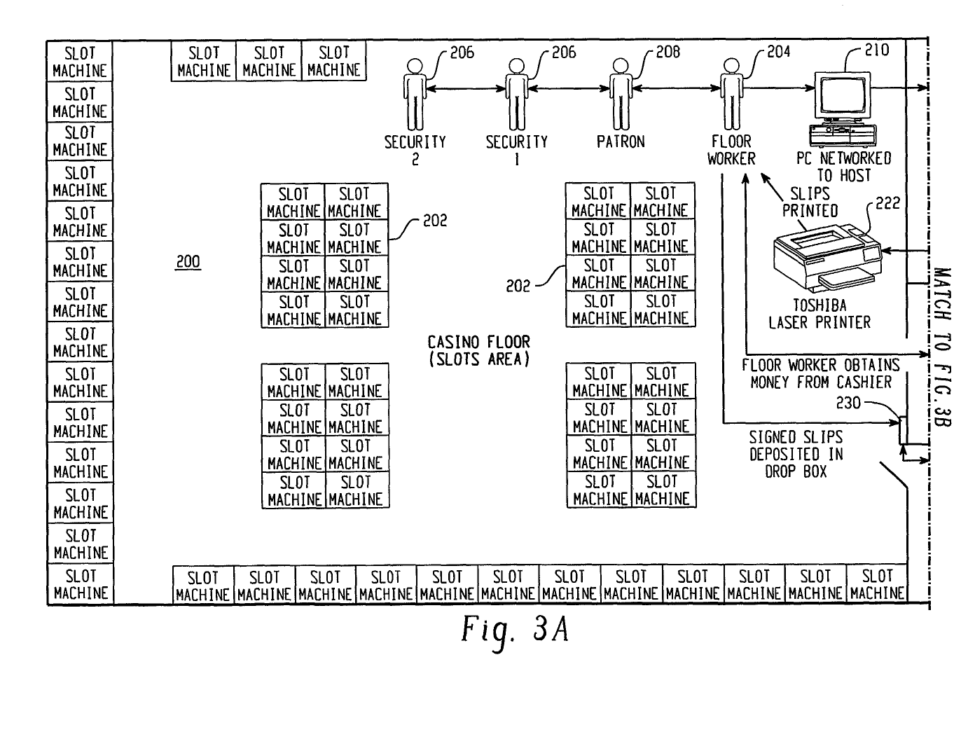

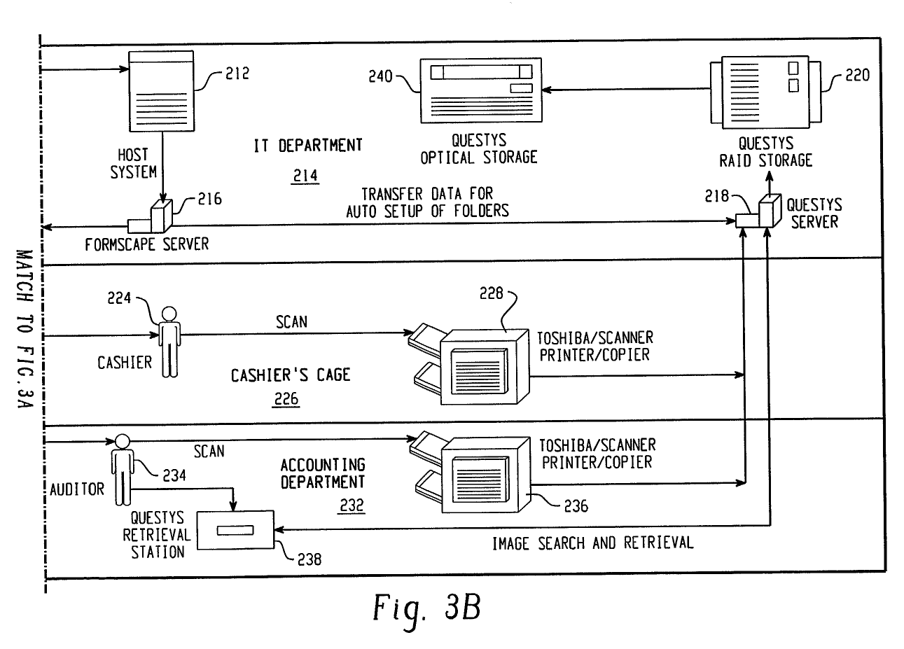

The present invention relates to a method and system for generating, archiving, and retrieving information and documents associated with winnings received by a patron from casino games. A flowchart illustrating the method is shown in FIGS. 1a, 1b, and 1c and a diagram illustrating the layout of a casino using the method and system is shown in FIGS. 2 and 3. The casino 200 is comprised of a plurality of slot machines 202 and preferably other casino games and gaming machines. Casino floor employees 204, security personnel 206, and patrons 208 are scattered throughout the casino. At 1, in response to a patron of the casino receiving winnings from a casino game or gaming machine, a casino floor employee sees a light flash or receives some indication that the patron has received notice of winnings from the casino game or gaming machine. The casino floor employee then access the system by appropriate means, such as swiping an identification card, enters a user name and password, and the like. Preferably, the to casino floor employee uses a personal computer housed in a kiosk 210 networked to a host system 212 located in the information technology department 214 as shown in FIGS. 2 and 3. The casino employee then inputs transaction information or data associated with the casino game and the winnings received. This transaction information is transmitted or virtually printed to a document output module as shown in 2. The document output module or server is shown as 216 in FIGS. 2 and 3. The document output module parses the transaction data to create index data representative of the transaction data.

The document output module is any suitable document output system or program known in the art. Examples of commercially available document output systems include, but are not limited to, FormScape developed by AFP Holdings Ltd., Stream Serve developed by Stream Serve, Inc., Jetform and Accelio provided by Adobe Systems, Incorporated, and Forms Partner developed by Source Technologies. The document output system in the preferred embodiment is FormScape.

The document output module then transmits the index data to a document archival and retrieval module. The document archival and retrieval module or server is shown as 218 in FIGS. 2 and 3. The document archival and retrieval module is any suitable document archival and retrieval system or program known in the art. Preferably, the document archival and retrieval system used is Questys developed by Decision Management Company, Inc.

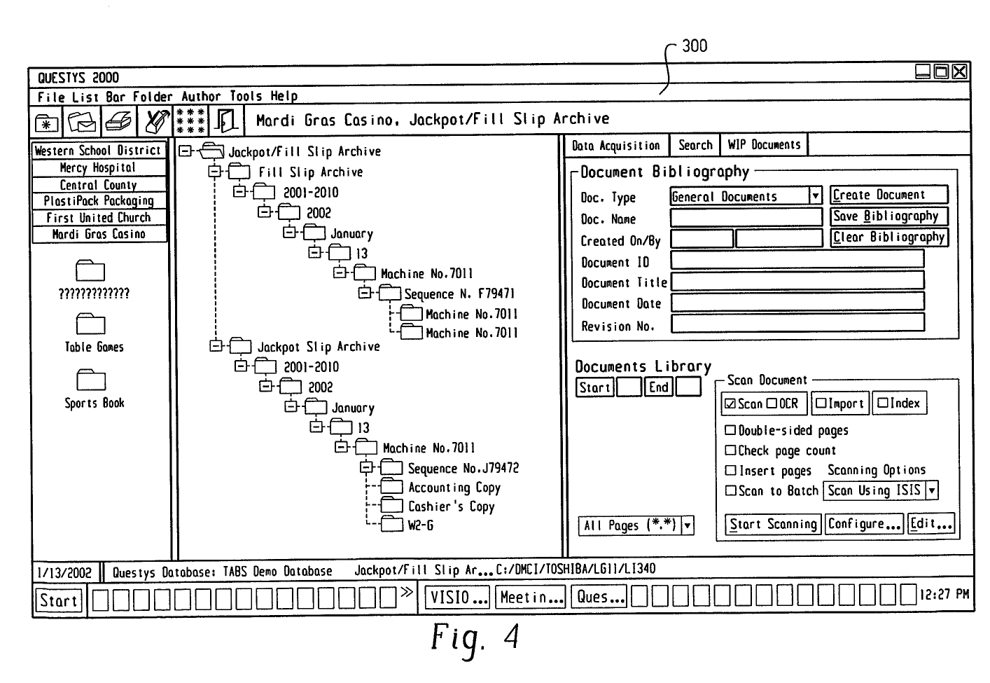

At 3, the document archival and retrieval module generates or creates at least one information record or folder associated with the casino game or gaming machine to which the transaction data relates. Preferably, these folders are stored in RAID storage which is shown as 220 in FIGS. 2 and 3. Preferably, the document archival and retrieval module creates a new fill slip or jackpot slip folder for gaming machine to which the transaction data relates. A sample screen 300 for the document archival and retrieval module is shown in FIG. 4.

In a preferred embodiment, the document archival and retrieval module includes a jackpot/fill slip archive folder 302. Within the jackpot/fill slip archive folder is a fill slip archive folder 304 and a jackpot slip archive folder 306. Each of the fill slip archive folder and the jackpot slip archive folders contain folders for storing information relating to a range of years 308, 310. Within those folders are folders for each year, of which the folders 312, 314 are for year 2002 are shown. Each of the 2002 folders contain folders for each month, of which January 316, 318 is shown, and folders for each day, of which the 13^{th} day 320, 322 is shown. Within each folder for each day, is a folder for each gaming machine 324, 326. Each gaming machine folder contains a folder for each transaction 328 and 330. Each transaction folder preferably contains folders for storing accounting information 332, 334, cashier information 336, 338, and tax information 340.

At 4, the document output module then formats the transaction data into a specified format for the forms generated by the system. The document output module also generating data representative of bar codes from the index data. The document output module also performs selected calculations on the transaction data, such as testing against selected criteria, determination of thresholds, and the like, which is included on the forms generated by the system.

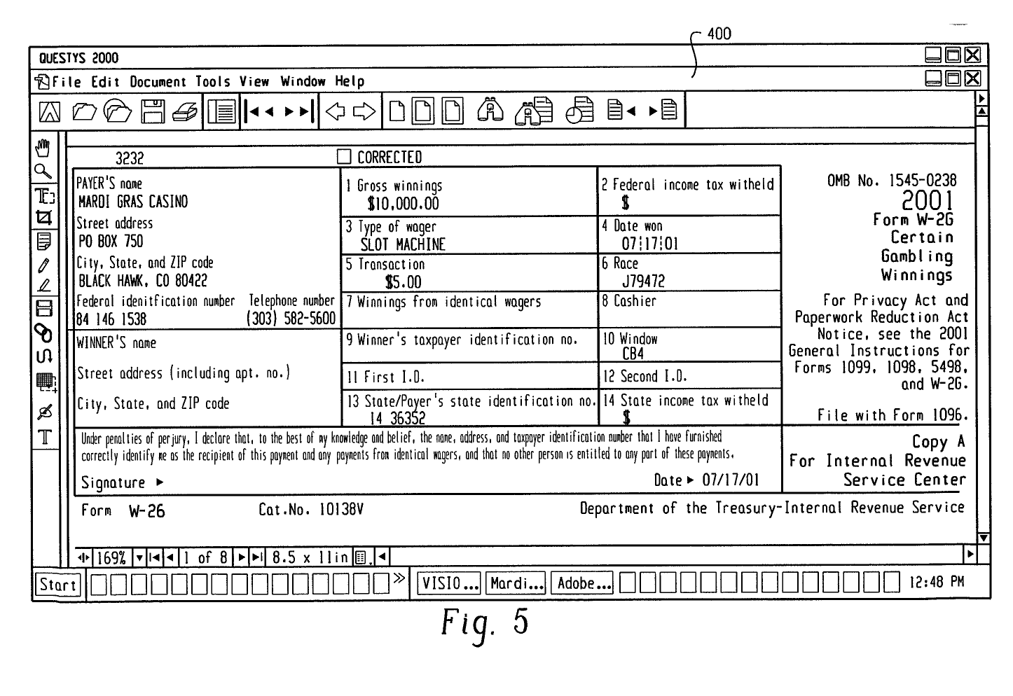

Next, at 5 the document output module performs conditional logic on the winnings to determine whether the winnings are over the tax reporting limit. If the winnings are over the tax reporting limit, the document output module generates the required W-2G tax form containing selected transaction information, tax information, and the bar codes associated therewith as shown at 6. Preferably, the document output module generates two copies of the W-2G form. A sample W-2G form 400 is shown in FIG. 5. Preferably, the document output module prints the form at a desired printer station, such as printer station 222 shown in FIGS. 2 and 3.

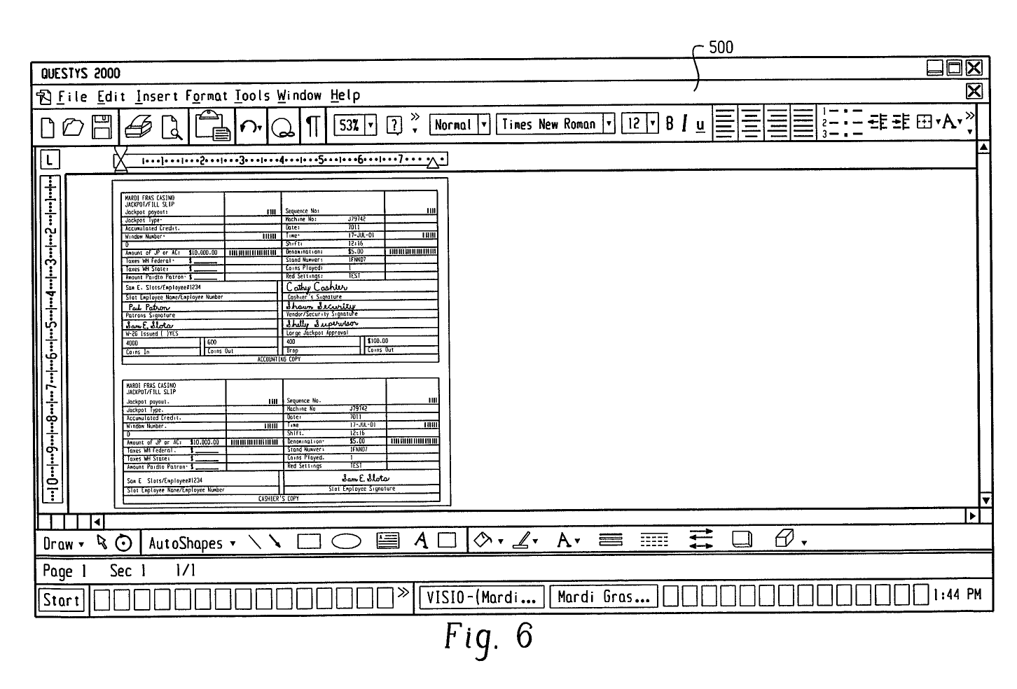

The document output module then generates at least one transaction related form containing form containing selected transaction information and the bar codes associated therewith as shown at 7. Preferably, the document output module generates an accounting form or copy and a cashier form or copy which contains selected information about the transaction and the bar codes associated therewith. A sample accounting and cashier form 500 is shown in FIG. 6. Preferably, the document output module prints the accounting and cashier forms at a selected printer station, such as printer station 222 shown in FIGS. 2 and 3.

As shown in 8, the casino floor employee signs the cashier copy. As shown at 9, the casino floor employee gives the cashier copy to a cashier 224 in the cashier cage 226 of the casino as shown in FIGS. 2 and 3 and the cashier retains the cashier copy. The casino floor employee also gives the accounting copy to the cashier. The cashier signs the accounting copy and gives it to the casino floor employee along with the winnings received by the patron.

The cashier cage contains at least one scanner/printer/copier device 228 (referred to as the scanner device) which is connected to the document archival and retrieval module as shown in FIGS. 2 and 3. The scanner device contains a scanning template for each cashier. The templates ensure that images scanned by the cashiers are transmitted to the correct directory in the document archival and retrieval module as shown in 10. The directory accepts and stores the scanned images of the cashier copy. As shown in 11, within each directory there is a folder for each cashier.

The cashier copies are batch scanned into the document archival and retrieval module as tif images at the end of each cashier's shift as shown in 12. The resulting tif images are automatically archived to a directory as shown in FIG. 4. The scanner device automatically names each tif image using a sequential number plus the system month and date.

In an alternative embodiment, the cashier cage also comprises a document archival and retrieval module workstation, shown as 242, in which the cashier manually inputs the information from the cashier copy into the document archival and retrieval module instead of scanning the cashier copy. The cashier also enters end-of-shift reconciliation reports into the workstation which are then transmitted to the document archival and retrieval module.

Regarding the accounting copy, as shown at 13, the casino floor employee completes the “Coins In”, “Coins Out”, “Drop”, and “Jackpot” fields, where applicable, on the accounting copy. The casino floor employee then signs the accounting copy as shown in 14. At 15, the casino floor employee determines whether it is a jackpot or fill transaction. As shown at 16, if it is a jackpot transaction, the casino floor employee obtains the patron's signature on the accounting copy and awards the jackpot to the patron. As shown at 17, if it is a fill transaction, the casino floor employee obtains a verified/security signature on the accounting copy.

For jackpot transactions, the document output module determines whether the jackpot is over the tax reporting limit, as shown in 18. If so, the casino floor employee manually completes both copies of the W-2G form, gives the two copies of the W-2G form to the patron as shown at 19. The patron then signs both copies of the W-2G form, gives one copy to the casino floor employee, and retains one copy. The casino floor employee then obtains the large jackpot approval signature from a floor manager or other authorized approval source as shown at 20. As shown at 21, the casino floor employee then drops the accounting copy, and if applicable, the W-2G copy into deposit dropbox. The deposit dropbox is shown as 230 in FIGS. 2 and 3.

An accounting department employee scans the accounting copies using a second scanner/printer/copier device as shown in 22 into the document archival and retrieval module as tif images. The accounting department is shown as 232, the accounting employee is shown as 234, and the second scanner device is shown as 236 in FIGS. 2 and 3. The tif images are archived into a jackpot/fill slip accounting copy images directory.

The accounting department also contains a document archival and retrieval module workstation 238 which is used by the accounting employees for searching and retrieving images archived in the document archival and retrieval module. The accounting employee enters a search request into the workstation which is transmitted to the document archival and retrieval module. The document archival and retrieval module transmits the images and data corresponding to the request to the workstation.

As shown at 23, the document archival and retrieval module periodically auto-imports the tif images from the cashiers copy directory and the accounting copy directory. In the cashier's copy directory, the document archival and retrieval module reads each folder name and associates each image with the appropriate cashier name. (Any special set up for the accounting directory?) The tif images in the two image directories are then deleted as shown at 24.

The document archival and retrieval module automatically performs optical character and bar code recognition on the cashier copy, the accounting copy, and the W-2G images as shown at 25. The cashier name data is appended to each appropriate cashier copy and stored as a .txt file.

The document archival and retrieval module then sends the W-2G images to a W-2G queue as shown at the 26.

At 27, the document archival and retrieval module determines if there are two images per transaction, or three if there is W-2G form. If not, folders with missing images are sent to a Missing Image queue as shown at 28.

If there are two images (or three where applicable) per transaction, the document archival and retrieval module determines if the optical character reader and bar code recognition results match exactly as shown at 29. If not, folders with non-matching optical character and bar code recognition data are sent to a Misrecognized Data queue as shown at 30.

If the optical character and bar code recognition results match, the accounting copy and cashier copy are images and data are filed to the correct document archival and retrieval module folders automatically as shown at 31. The document archival and retrieval module then automatically archives the images and data as shown at 32. The images are stored in document archival and retrieval module optical storage component shown as 240 in FIGS. 2 and 3.

As shown at 33, the document archival and retrieval module checks the Missing Image, Misrecognized Data, and W-2G queues at predetermined time interval. The document archival and retrieval module first determines if all of the queues are empty as shown at 34. If so, the document archival and retrieval module will check again after the predetermined time interval.

If all of the queues are not empty, then the document archival and retrieval module determines if there folders with missing images present as shown at 35. If not, the method proceeds to step 38. If so, at 36, the document archival and retrieval module writes a message regarding the missing images to an Imaging Issues Log shown as 50 requesting corrective action. A quality control operator, at 37, investigates the cause. If the cause is found, the missing documents are scanned into the document archival and retrieval module as shown in step 12 or 22. The quality control operator keypunches the actions performed into the Imaging Issues Log.

At 38, the document archival and retrieval module next determines if there are folders with mismatched optical character versus bar code recognition results. If there are no folders with mismatched results, the method proceeds to step 42. If so, then, at 39, the document archival and retrieval module writes a message and sends the images, optical character data, and bar code data to the Imaging Issues Log requesting corrective action. The quality control operator views the images and data and makes corrections to the images and data within the document archival and retrieval module as shown in 40. The quality control operator keypunches the actions performed into the Imaging Issues Log. The accounting copy and cashier copy images and data are filed to the correct folders in the document archival and retrieval module automatically as shown in 42. The document archival and retrieval module archives the accounting copy and the cashier copy images and data as shown in 46.

At 42, the document archival and retrieval module determines if there are any folders with W-2G forms. If not, the method returns to step 34. If there are folders containing W-2G forms, the document archival and retrieval module writes a message to the Imaging Issues Log notifying the quality control operator that of W-2G images and the need for data input as shown at 43. The quality control operator views the W-2G images, keypunches the handwritten W-2G data into the document archival and retrieval module, and keypunches the actions performed into the Imaging Issues Log as shown at 44. The images and data of the W-2G forms are filed to the correct folder in the document archival and retrieval module automatically as shown at 45. After step 44, the document archival and retrieval module also checks to determine if the queues are all empty as shown in 34. At 46, the document archival and retrieval module automatically archives the W-2G images and data.

The preferred equipment specifications for the document archival and retrieval module, the document output module, and the scanner devices used in the present invention are set forth in Appendix A. However, as will be appreciated by one skilled in the art, different equipment and configurations are suitably used without departing from the scope of the present invention.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

What is claimed is:

1. An automated method for generating, archiving, and retrieving selected documents associated with winnings received by a patron from a casino game using a distributed computing system, the method comprising:
receiving system user input comprising transaction information representative of data associated with a patron receiving notice of winnings from a selected casino game;
transmitting the transaction information to a document output module;
parsing the transaction information to create index data representative of the transaction information;
generating data representative of bar codes from the index data;
testing whether the winnings are over a specified tax reporting limit;
upon a determination in the step of testing, that the winnings are over a specified tax reporting limit, generating at least one tax form containing selected transaction information, tax information, and the bar codes associated therewith;
generating at least one transaction related form containing selected transaction information and the bar codes associated therewith;
generating at least one of the forms to at least one system user and the patron, wherein the at least one form is adapted to receive addition required information from at least one system user and the patron to complete same;
selectively scanning the at least one completed into a document archival and retrieval module;
performing optical character and bar code recognition on the at least one scanned form to determine if the optical character and bar code readings match and if a required number of images per transaction were scanned;
if the readings do not match or there are not the required number of images per transaction, transmitting the rejected readings and the corresponding image to a rejection queue, wherein in the rejection queue, the rejected readings and corresponding images are reviewed and corrections are made to the at least one form associated therewith; and
selectively archiving the at least one scanned form in a specified location within the document archival and retrieval module.

2. The method according to claim 1 further comprising the step of transmitting the index data to the document archival and retrieval module wherein the document archival and retrieval module uses the index data to create at least one information record associated with the casino game to which the transaction information relates.

3. The method according to claim 2 wherein the at least one scanned form is archived in the at least one information record.

4. The method according to claim 2 wherein the document archival and retrieval module uses the index data to create accounting information records for archiving accounting information for the casino game to which the transaction relates, cashier information records for archiving cashier information for the casino game to which the transaction relates, and tax information records for archiving tax information for the casino game to which the transaction relates.

5. The method according to claim 1 wherein the method further comprises the steps of formatting the transaction information and performing selected calculations on the transaction information for inputting the formatted transaction information and selected calculations into the generated forms.

6. The method according to claim 1 wherein the document output module determines if the winnings are over a specified amount.

7. The method according to claim 1 wherein the document output module generates the at least one tax form and the at least one transaction related form and prints the forms at selected destinations.

8. The method according to claim 7 wherein the tax form generated is a W-2G form.

9. The method according to claim 8 wherein the W-2G form is completed, the completed form is scanned into the document archival and retrieval module, and the scanned form is archived in a tax information record.

10. The method according to claim 7 wherein the transaction related forms generated are an accounting form which contains selected information about the transaction and a cashier form which contains selected information about the transaction.

11. The method according to claim 10 wherein the cashier form is completed and transmitted to a cashier module and accounting form is completed and transmitted to an accounting module.

12. The method according to claim 11 wherein the cashier form and the accounting form are scanned into the document archival and retrieval module and archived in a selected location.

13. The method according to claim 1 wherein the document archival and retrieval module performs the optical character recognition and bar code recognition.

14. An automated system for generating, archiving, and retrieving selected documents associated with winnings received by a patron from a casino game using a distributed computing system, the system comprising:
means adapted for receiving system user input comprising transaction information representative of data associated with a patron receiving notice of winnings from a selected casino game;
means adapted for transmitting the transaction information to a document output module;
means adapted for parsing the transaction information to create index data representative of the transaction information;
means adapted for generating data representative of bar codes from the index data;
means adapted for testing whether the winnings are over a specified tax reporting limit;
upon a determination in the step of testing that the winnings are over a specified tax reporting limit, means adapted for generating at least one tax form containing selected transaction information, tax information, and the bar codes associated therewith;
means adapted for generating at least one transaction related form containing selected transaction information and the bar codes associated therewith;
means adapted for generating at least one of the forms to at least one system user and the patron, wherein the at least one form is adapted to receive addition required information from at least one system user and the patron to complete same;
means adapted for selectively scanning the at least one completed into a document archival and retrieval module;
means adapted for performing optical character recognition and bar code recognition on the at least one scanned form to determine if the optical character reader recognition and bar code readings match and if a required number of images per transaction were scanned;
if the readings do not match or there are not the required number of images per transaction, means adapted for transmitting the rejected readings and the corresponding image to a rejection queue, wherein in the rejection queue includes means adapted for reviewing the rejected readings and corresponding images, and means adapted for correcting the at least one form associated therewith; and
means adapted for selectively archiving the at least one scanned form in a specified location within the document archival and retrieval module.

15. The system according to claim 14 further comprising means adapted for transmitting the index data to the document archival and retrieval module wherein the document archival and retrieval module includes means adapted for creating at least one information record associated with the casino game to which the transaction information relates based on the index data.

16. The system according to claim 15 wherein the at least one scanned form is archived in the at least one information record.

17. The system according to claim 16 wherein the document archival and retrieval module includes means adapted for creating accounting information records for archiving accounting information for the casino game to which the transaction relates, cashier information records for archiving cashier information for the casino game to which the transaction relates, and tax information records for archiving tax information for the casino game to which the transaction relates.

18. The system according to claim 14 wherein the document output module includes means adapted for formatting the transaction information and means adapted for performing selected calculations on the transaction information for inputting the formatted transaction information and selected calculations into the generated forms.

19. The system according to claim 14 wherein the document output module includes means adapted for determining if the winnings are over a specified amount.

20. The system according to claim 14 wherein the document output module includes means adapted for generating the at least one tax form and the at least one transaction related form and prints the forms at selected destinations.

21. The system according to claim 20 wherein the tax form generated is a W-2G form.

22. The system according to claim 21 wherein the W-2G form is completed, the completed form is scanned into the document archival and retrieval module, and the scanned form is archived in a tax information record.

23. The method according to claim 21 wherein the transaction related forms generated are an accounting form which contains selected information about the transaction and a cashier form which contains selected information about the transaction.

24. The system according to claim 23 wherein the cashier form is completed and transmitted to a cashier module and accounting form is completed and transmitted to an accounting module.

25. The system according to claim 24 wherein the cashier form and the accounting form are scanned into the document archival and retrieval module and archived in a specified location.

26. The system according to claim 14 wherein the document archival and retrieval module includes the means adapted to perform the optical character recognition and bar code recognition.
